(19) United States
(12) Patent Application Publication
(10) Pub. No.: US 2012/0099080 A1
(43) Pub. Date: Apr. 26, 2012

(54) DEVICE AND METHOD FOR TRANSILLUMINATING A FILM

(75) Inventors: Rainer Kaus, Hochheim (DE); Klaus Anderle, Darmstadt (DE); Markus Hasenzahl, Riedstadt (DE)

(73) Assignee: DFT Digital Film Technology Holding GmbH, Weiterstadt (DE)

(21) Appl. No.: 13/264,859

(22) PCT Filed: Apr. 15, 2010
(86) PCT No.: PCT/EP2010/002314

§ 371 Date: Jan. 6, 2012

(30) Foreign Application Priority Data
Apr. 17, 2009 (DE) 10 2009 017 534.2

(51) Int. Cl. G03B 1/42

(52) U.S. Cl. 352/40; 352/157

(57) ABSTRACT

An apparatus for transilluminating a film includes a light source emitting a light beam for transilluminating the film, a film guide for guiding the film such that the light beam can transilluminate a section of the film, a film feed for feeding the film to the film guide, and a film removal for removing the film from the film guide. The film guide has a support designed for rotation about a rotation axis running through the center of the support and a rotationally symmetric circumferential surface. The film can be supported on the circumferential surface at least with part of the width thereof over a section of the circumferential surface. The light beam generated by the light source passes through the film when the film is supported on the circumferential surface at least with part of the width thereof over a section of the circumferential surface.

The invention relates to a device and a method for transilluminating a film.

It is known from practical applications to transilluminate films and to further process, for example to record or digitize the light passing through the film during transillumination. This method is used, for example, for digitizing the film sequence obtained from the sequence of images on the film in order to allow post-processing of the film sequence. Such methods are also used for archiving film material, wherein the light signals produced by the transillumination are converted into electrical signals and these electrical signals are stored, optionally after digitalization. The transillumination of a film also makes it possible to read out the audio signal applied on the film in optical form by transilluminating the optical reproduction of the audio signal and converting the resulting light signal into an audio signal by suitable means. Transillumination of a film can also be used to identify the position of the film. For identifying the position of the film, for example, perforation holes or other reference markings of the film can be used, if present. In practical applications, different methods are known for determining the position of a film in an apparatus by transilluminating the perforation holes.

When transilluminating a film moving through an apparatus, there is a fundamental problem in that the movements to be applied to the film may cause vibrations of the film. These vibrations make it more difficult to process the light signals generating during the transillumination of the film. Frequently, the light signals generated during transillumination then pass through optics which may also include lenses. The optics is frequently adjusted such that the focus of the lens is located at a certain point relative to the film. The ratio of the position of the focus to the position of the film changes when the film vibrates. These differences must be corrected either by changing the focus of the lens or by taking into account the change of the relative position of the focus with respect to the film in a possible later data processing operation.

It is known from DE 195 40 005 A1 to guide a film through a curved guide in the running direction of the film, wherein the raised lateral slides are used as support for the film edges. In the apparatus described therein, the film is supported by an air cushion at least in the gap formed between the runners, opposing undesirable bending. In this way, undesirable bending of the film can be eliminated or at least reduced to an unobjectionable level. With such air cushion, the film can be raised without making contact, thereby preventing scratches and improving film scanning and/or imaging. The approach described in DE 195 40 005 A1 has the disadvantage that special components must be provided for producing the air cushion. This makes the structure of an apparatus designed in this manner quite complex.

In view of this background, it is the object of the invention to provide an apparatus for transilluminating a film while improving guiding of the film.

This object is attained with an apparatus according to claim 1 and with a method according to claim 13. Advantageous embodiments of the invention are recited in the dependent claims and described in the following description.

The invention is based on the core concept to place at least parts of the film, for example the edges of the film, on a surface section of a film guide, wherein this surface section is moved, preferably at the same speed at which the film is moved in this region of the apparatus of the invention. Damage to the film can be prevented by reducing the relative speed between the film and the film guide, or in a particularly preferred embodiment, by eliminating a relative speed between the film and the film guide.

The apparatus according to the invention for transilluminating a film has a light source from emitting a light beam with which the film is to be transilluminated. The apparatus according to the invention also includes a film guide with which the film can be guided such that the light beam can transilluminate a section of the film. The apparatus according to the invention has a film feed with which the film can be fed to the film guide and a film removal with which the film can be removed from the film guide.

The film guide according to the invention has a support which is constructed for rotation about a rotation axis extending through the center of the support and a circumferential surface which is formed rotationally symmetric with respect to the rotation axis, wherein the film can be supported at least with part of the width thereof over a section of the circumferential surface. The envelope angle defining the section of the circumferential surface over which the film can be supported on the circumferential surface at least with part of the width thereof can be selected depending on the application. In a preferred embodiment, the envelope angle is greater than 90°, preferably greater than 145°, and particularly preferred greater than 180°.

The apparatus according to the invention includes a light source which is arranged such that the light beam exiting from the light source transilluminates the film when the film is supported at least with part of the width thereof on the circumferential surface over a section of the circumferential surface.

The structure of the film guide used with the apparatus according to the invention has the advantageous result that the film guided by the film guide is supported at the time when the light beam passes through the film at least with portions of its width on a rotatable circumferential surface of the support which preferably rotates at the same speed, so that only a small, or preferably no relative speed at all, exists between the film guide and the film. This reduces or even prevents the film from rubbing against the film guide and consequently the undesirable effects produced by rubbing. Scratching of the film is reduced or even completely eliminated. Undesirable film movements are reduced, or even prevented, for example jumping of a film which may occur during a transition from static friction to dynamic friction.

The support of the film guide may be formed by a ring-shaped or disk-shaped component. For example, the circumferential surface, on which the film may be at least partially supported, may be constructed and the support arranged relative to the film feed and the film removal such that the film is supported on the circumferential surface essentially over its full width. For this purpose, at least the part of the support, or the part of the circumferential surface on which the part of the film to be transilluminated is supported, may be form of a light-transparent material.

In a preferred embodiment, however, the film is not entirely supported on the circumferential surface. In a particularly preferred embodiment, the film guide has two supports which are arranged opposite each other such that a film with a predetermined width can be supported with its right edge on the circumferential surface of the first support and with its left edge on the circumferential surface of the second support. A film with a predetermined width is to be understood as a film which is constructed according to a format normally used in the film industry. Particularly preferred is a film with a predetermined width having one of the following film formats: normal 8; super 8; single 8; 9. 5 mm; 16 mm; super 16; 35 mm silent movie; 35 mm; 35 mm Academy; 35 mm (1.66); 35 mm (1.85); Cinemascope; Techniscope; super 35 (3-perf); super 35 (4-pert); Maxivision; Vistavision; Technirama; Cinerama; Cinemiracle; 55 mm; Panavision Super 70; Todd-AO; DEFA 70; Ultra Panavision 70 (MGM Camera 65); Dimension 150; Showscan; IMAX; IMAX HD.

In a preferred embodiment, the two opposing supports are ring-shaped or disk-shaped.

In a preferred embodiment, the support is constructed so as to laterally guide the right and/or left edge of the film. For example, the side face of the support forming the circumferential surface may have a projection or a bevel delimiting the circumferential surface. The film supported with part of the its width on the circumferential surface is then preferably in contact with its edge at this projection or at the start of the bevel. Alternatively or in addition, the film guide may have at least one pretensioned guide roller which is arranged so as to laterally guide a film of a predetermined width. Such guide rollers are known, for example, from DE 196 12 880 A1, to which reference is made in its entirety with respect to the structure of a guide element with spring-bias guide rollers. In a preferred embodiment, at least one such guide roller is provided at the support. Preferably, the support has several such pre-biased guide rollers distributed along its circumference. Alternatively or in addition, a pressing disk can be provided which either presses the film from the side and which is for this purpose particularly shaped as a ring, or which presses the film onto the support from above.

In a preferred embodiment, the support has a distance between the circumferential surface and the center (radius) which is at least 1.5 times greater than the width of a predetermined film. The greater the selected radius, the less is the film bent on the film guide.

In a preferred embodiment, the support(s) is/are supported for rotation. In this preferred embodiment, the support(s) is/are dragged by a film moved in the direction of its lengthwise extent (running direction of the film). This simplifies the structure of the apparatus according to the invention and simultaneously provides the advantageous effect that the support is moved substantially at the same speed as the film. According to an alternative embodiment, the support(s) may be driven by a separate drive.

In a preferred embodiment, an aperture is arranged between the light source and the location at which a light beam radiated from the light source transilluminates the film supported on the support. The size of the gap forming the aperture can be adapted to the employed transillumination method. Preferably, a transillumination method is used wherein the film is transilluminated line-by-line. The width of the aperture (extent in the running direction of the film) is hereby matched to the shape of a line camera arranged in the direction of the beam path. Alternatively, the width of the aperture can be selected such that an entire image of the image sequence on the film is transilluminated. The length of the aperture (perpendicular to the running direction of the film) can, for example, be adjusted so as to illuminate only the width of an image on the film. Alternatively, the aperture may be constructed to have a length such that also a potentially existing optical audio track or the perforation holes are transilluminated.

In a preferred embodiment, the apparatus includes a lens and/or a beam splitter through which a light beam emitted by the light source passes and which transilluminates the film supported on the support. The beam splitter may be constructed, for example, to separate the light beam according to colors. For example, a three-way beam splitter can be used which decomposes the light beam into the colors red, green, and blue. The apparatus according to the invention may have light detectors, for example line cameras, which convert the optical light signal into an electric signal.

In a preferred embodiment, the film feed and/or the film removal has at least one component configured to apply a tension to the film that is fed by the film feed, guided over the film guide and removed by the film removal. The vibrations of the film are reduced by guiding the film over the film guide in a tensioned state.

In a preferred embodiment, the apparatus according to the invention has a drive capable of moving the film in the direction of its lengthwise extent (running direction of the film).

In a preferred embodiment, the light source for producing a light beam is arranged in a space that is delimited in the radial direction by the rotationally symmetric circumferential surface, when viewed from the center of the apparatus.

In a preferred embodiment, the apparatus has a second light source emitting a second light beam which transilluminates the film when the film is supported at least with a portion of the its width on a section of the circumferential surface. The second light beam may be used, for example, to detect the position of the perforation holes of the film supported on the support. The additional light source may also be used to read out additional information applied on the film. In a preferred embodiment, an aperture is also provided with the second light source between the light source and the location where a light beam emitted from the second light source transilluminates the film supported on the support. In a particularly preferred embodiment, this aperture is specifically adapted to the regions of the film to be transilluminated with the second light beam, for example the expected position of the perforation holes or the expected position of the information additionally applied on the film.

In a preferred embodiment, the film guide and/or the light source are arranged on the apparatus so as to be exchangeable. An exchange of the film guide may be required, for example, when the apparatus according to the invention must be converted from transilluminating a film having a specified first format to transilluminating a film having a specified second format. However, the apparatus according to the invention may also be equipped with a universal film guide suitable for transilluminating any film format. However, the film is better guided when the film guide is matched to the corresponding format of the film. The light source can be embodied as one or several light emitting diodes or another illumination means, for example xenon lamps or lasers. The light source may also be the end of an optical guide, which guides light beams of a remote illumination means to the desired location for radiation.

In a preferred embodiment, the apparatus may include a light guide arranged between a light source and a location where the light should be radiated from for the purpose of transilluminating the film. In this way, the light source may be arranged at a different location and the light guided with the light guide to the location where it should exit for transilluminating the film. When using a light guide, an aperture may be provided in a preferred embodiment which is arranged between the end of the light guide and the film. In a particularly preferred embodiment, however, an aperture is eliminated and the light is radiated due to the shape and arrangement of the light guide so that it transilluminates the film in the desired manner, for example as an arrow strip of light.

In a preferred embodiment, the apparatus according to the invention is used for scanning a film, in particular for generating electrical, particularly preferred digital signals which include the optical information recorded on the film.

The invention will now be described with respect to an example which merely represents an exemplary embodiment. It is shown in:

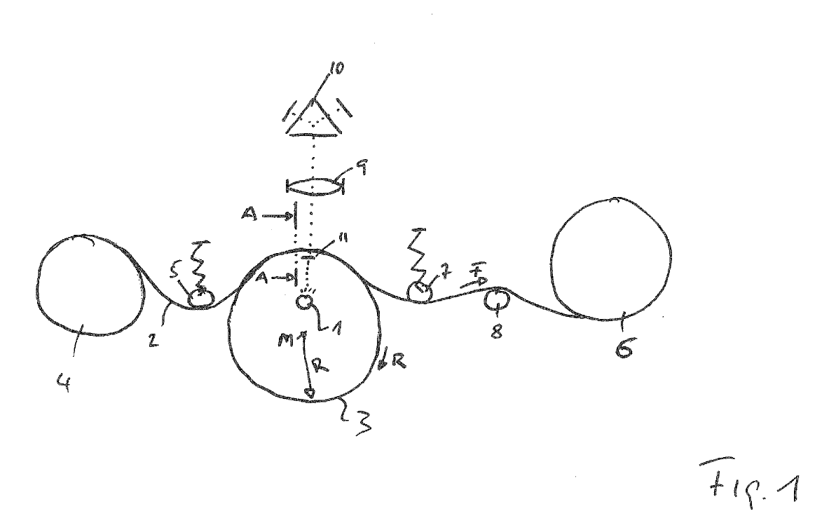

FIG. 1 a schematic side view of the apparatus according to the invention, and

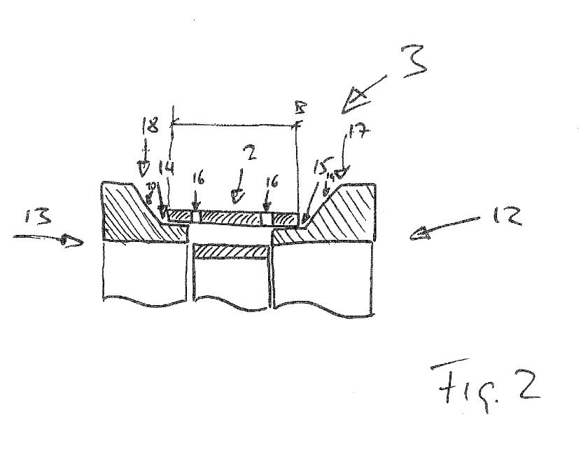

FIG. 2 a cross-sectional view of a detail of the apparatus according to the invention taken along the line A-A of FIG. 1.

FIG. 1 shows an apparatus for transilluminating a film with a light source 1 emitting a light beam for transilluminating the film 2. The film 2 is guided through a film guide 3 so that the light beam transilluminates a section of the film 2. The apparatus has a film feed with a film spool 4 and a pretensioned tensioning roller 5. The apparatus furthermore includes a film removal which includes a film spool 6, a spring-biased tensioning roller 7 and a drive roller (capstan) 8. The apparatus according to the invention also has a lens 9 and a beam splitter 10. The light emerging from the light source 1 passes through the film 2 and subsequently through the lens 9 and the beam splitter 10.

An aperture 11 is provided between the light source 1 and the location where a light beam radiated from the light source 1 transilluminates the film 2 supported on the support.

The film is moved by the drive roller 8 (capstan) in the direction of its lengthwise extent (running direction of the film).

The rollers 5 and 7 pretensioned with the springs apply a tension force on the film 2 that is fed by the film feed, guided over the film guide 3 and removed by the film removal.

As seen from the view of FIG. 2, the film guide 3 has two supports 12, 13 which are constructed for rotation in a rotation direction R about a rotation axis extending through the center M of the supports 12, 13. The supports 12, 13 have each circumferential surfaces 14, 15 constructed rotationally symmetric with respect to the rotation axis, wherein the film 2 is supported on the circumferential surface 14, 15 at least over part of its width over a section of the circumferential surface 14, 15. FIG. 2 illustrates that the film 2 is supported with its right marginal region and with its left the marginal region on the respective circumferential surfaces. The perforation holes 16 of the film are positioned outside the circumferential surfaces 14, 15. The side face 17, 18 of the respective support 12, 13 forming the circumferential surface 14, 15 has a bevel 19, 20 which laterally delimits the circumferential surface 15, 14.

1-14. (canceled)

15. An apparatus for transilluminating a film, comprising:
a light source emitting a light beam for transilluminating the film,
a film guide for guiding the film so that the light beam transilluminates a section of the film, with the film guide comprising a support constructed for rotation about a rotation axis extending through a center of the support and having a circumferential surface formed rotationally symmetric with respect to the rotation axis,
a film feed for feeding the film to the film guide, and
a film removal for removing the film from the film guide,
wherein the light source is arranged so that the light beam passes through the film when at least a portion of a width of the film is in contact with the circumferential surface along a section of the circumferential surface.

16. The apparatus of claim 15, wherein the film guide comprises two supports, each of the two supports having a corresponding rotation axis extending through a center of the support and being constructed for rotation about the corresponding rotation axis, with each of the two supports further having a corresponding circumferential surface formed rotationally symmetric with respect to the corresponding rotation axis of each support, wherein at least a portion of a width of the film is in contact with a corresponding circumferential surface over at least a section of the corresponding circumferential surface.

17. The apparatus of claim 15, wherein the circumferential surface is formed by a side surface of the support and comprises a projection or a bevel delimiting the circumferential surface.

18. The apparatus of claim 15, wherein the film guide comprises at least one pretensioned guide roller which is arranged so as to laterally guide a film of a predetermined size.

19. The apparatus of claim 18, wherein the guide roller is arranged on the support.

20. The apparatus of claim 16, wherein the two supports are arranged opposite each other such that a right edge of a film with a predetermined width is in contact with the circumferential surface of a first of the two supports and a left edge of the film with the predetermined width is in contact with the circumferential surface of the second support.

21. The apparatus of claim 15, wherein the support has a radius which is at least 1.5 times greater than a width of a film.

22. The apparatus of claim 15, wherein the support is supported for rotation.

23. The apparatus of claim 15, further comprising an aperture arranged between the light source and a location where the light beam exiting from the light source transilluminates the film in contact with the support.

24. The apparatus of claim 15, further comprising at least one of a lens and a beam splitter arranged between the light source and a location where the light beam exiting from the light source transilluminates the film in contact with the support.

25. The apparatus of claim 15, wherein at least one of the film feed and the film removal comprises at least one component constructed for applying a tension force to the film which is fed by the film feed, guided over the film guide and removed by the film removal.

26. The apparatus of claim 15, further comprising a drive capable of moving the film in a lengthwise direction (running direction) of the film of the film.

27. A method for transilluminating a film, comprising the steps of:
transilluminating the film with a light beam exiting a light exit,
guiding the film through a film guide to transilluminate with the light beam a section of the film, said film guide comprising a support constructed for rotation about a rotation axis extending through a center of the support and having a circumferential surface formed rotationally symmetric with respect to the rotation axis,
feeding the film to the film guide with a film feed, and
removing the film from the film guide with a film removal, wherein the light source is arranged so that the light beam passes through the film when at least a portion of a width of the film is in contact with the circumferential surface along a section of the circumferential surface.
